(19) United States
(12) Patent Application Publication
(10) Pub. No.: US 2026/0160712 A1
(43) Pub. Date: Jun. 11, 2026

(54) X-RAY INSPECTION APPARATUS AND X-RAY INSPECTION SYSTEM

(71) Applicant: Rigaku Corporation, Tokyo (JP)

(72) Inventors: Kiyoshi OGATA, Tokyo (JP); Kazuhiko OMOTE, Tokyo (JP); Naoki MATSUSHIMA, Tokyo (JP); Markus KUHN, Hillsboro, OR (US); Hiroshi MOTONO, Tokyo (JP); Yohei SHIMOSAKO, Tokyo (JP); Michiko MORI, Tokyo (JP); Yoshihiro TAKEDA, Tokyo (JP); Takumi OTA, Tokyo (JP); Raita HIROSE, Tokyo (JP); Jih Perng LEU, Hillsboro, OR (US); Katsutaka HORADA, Tokyo (JP); Makoto AOYAGI, Tokyo (JP); Benjamin Wilson BUFORD, Hillsboro, OR (US); Yoshimitsu SHIMANE, Tokyo (JP)

(73) Assignee: Rigaku Corporation, Tokyo (JP)

(21) Appl. No.: 19/374,063

(22) Filed: Oct. 30, 2025

Related U.S. Application Data
(60) Provisional application No. 63/730,172, filed on Dec. 10, 2024.

(51) Int. Cl. G01N 23/044; G01N 23/083; G01N 23/20008

(52) U.S. Cl. CPC G01N 23/044; G01N 23/083; G01N 23/20008; G01N 2223/3306; G01N 2223/6116; G01N 2223/6462

(57) ABSTRACT

An X-ray inspection apparatus and an X-ray inspection system capable of observing a sample using a detector suitable for each application are provided in a single apparatus. An X-ray source for irradiating parallel X-rays with a plate-shaped sample, a sample stage for holding the sample, a plurality of detectors each having a different resolution and detecting a projection image of X-rays transmitted through the sample, a switching mechanism for switching the detectors, and an adjusting mechanism for adjusting an arrangement of each of the detectors independently are comprised, and the adjusting mechanism enables each of the detectors to move in a direction close to or away from the sample along an optical axis of the irradiated X-rays.

### CROSS-REFERENCE TO RELATED APPLICATION

This application claims priority from U.S. Provisional Application No. 63/730,172 filed on Dec. 10, 2024, the entire contents of which are incorporated herein by reference.

### FIELD OF THE INVENTION

The present invention relates to an X-ray inspection apparatus and an X-ray inspection system used for inspection of a sample and acquiring a projection image of X-rays.

### DESCRIPTION OF RELATED ART

Conventionally, an apparatus for inspecting an internal structure of a sample such as a wafer using X-rays in a semiconductor manufacturing process has been known. Such apparatuses include those that detect diffracted X-rays, such as topography measurements and rocking curve measurements, and those that utilize projection images, such as CT measurements and laminography measurements.

For example, Patent Document 1 discloses an integrated X-ray single crystal evaluation apparatus that realizes topography measurement and rocking curve measurement by a single apparatus. In the apparatus described in Patent Document 1, a detector suitable for each measurement is switched by moving the entire detection unit on the guide rod in a direction perpendicular to the incident diffraction X-rays.

### PATENT DOCUMENT

Patent Document 1: JP 4495631 B

### NON-PATENT DOCUMENT

However, in the diffraction method and the projection method, specifications required for the apparatus differ much. For example, in a diffraction apparatus, in order to obtain information about a crystal structure, high 2θ positional accuracy is required, and a dynamic range in which a scattered signal from a minute region can be measured with high accuracy is required. On the other hand, in the projection apparatus, in order to observe the shape of a pattern defect, a foreign substance, and a structure, observation can be performed in a large field of view, and a high spatial resolution is required.

### SUMMARY OF THE INVENTION

The present invention has been made in view of such circumstances, and an object of the present invention is to provide an X-ray inspection apparatus and an X-ray inspection system capable of observing a sample using a detector suitable for each application in a single apparatus that can cope with both a case of observing a large range at a low magnification and a case of observing a small range at a high magnification.
(1) In order to achieve the above object, the X-ray inspection apparatus of the present invention comprises an X-ray source for irradiating parallel X-rays with a plate-shaped sample, a sample stage for holding the sample, a plurality of detectors each having a different resolution and detecting a projection image of X-rays transmitted through the sample, a switching mechanism for switching the detectors and an adjusting mechanism for adjusting an arrangement of each of the detectors independently, and the adjusting mechanism enables each of the detectors to move in a direction close to or away from the sample along an optical axis of the irradiated X-rays.
(2) Further, the X-ray inspection apparatus according to (1) further comprises an optical microscope for setting an X-ray irradiation position on a surface of the sample and aligning an optical axis of the irradiated X-ray with a reference position of the detector.
(3) Further, in the X-ray inspection apparatus according to (1), the detectors include a detector for specifying a position of a defect in the sample and a detector for observing a state of the defect.
(4) Further, in the X-ray inspection apparatus according to (1), the sample stage is capable of rotating the sample around a sample axis perpendicular to the surface of the sample, in an imaging measurement, an optical axis of the irradiated X-ray is aligned with the sample axis, and the projection image is acquired, and in a laminography measurement, an intersection between an optical axis of the irradiated X-ray and the sample axis is aligned with an observation position of the sample, and the optical axis of the irradiated X-ray is tilted from the sample axis, and the plurality of projection images are acquired while rotating the sample.
(5) Further, in the X-ray inspection apparatus according to (4), the detectors include a detector used only for the imaging measurement and a detector used for both the imaging and the laminography measurement.
(6) Further, in the X-ray inspection apparatus according to (1), the plurality of detectors are arranged such that central axes each in a center of a detection surface are arranged in a row, and the switching mechanism switches the detectors by moving the entire plurality of detectors along a direction of the arrangement.
(7) Further, the X-ray inspection system of the present invention comprises the X-ray inspection apparatus according to (1) above and a control apparatus for controlling the X-ray inspection apparatus, and the control apparatus adjusts the arrangement of the switched detector by pattern recognition of the projected image.

### BRIEF DESCRIPTION OF THE DRAWINGS

FIGS. 1A and 1B show a sample and package to be inspected, respectively.

FIGS. 2A to 2C are schematic diagrams showing arrangements of an X-ray source and detector for imaging and laminography of central and peripheral regions, respectively.

FIGS. 3A and 3B are a schematic diagram and block diagram of an X-ray inspection system of the present invention, respectively.

FIGS. 4A and 4B are cross-sectional and perspective views of an X-ray inspection apparatus, respectively.

FIG. 5 is a perspective view showing an intermediate transfer system.

FIGS. 6A and 6B are perspective and exploded views showing a main unit, respectively.

FIGS. 7A to 7C are side cross-sectional and perspective views for different arrangements showing an incident unit, respectively.

FIG. 8 is a perspective view showing a sample stage.

FIG. 9 is a perspective exploded view showing a sample stage.

FIG. 10 is a perspective cross-sectional view showing a part of the main unit.

FIG. 11 is a perspective exploded view of the receiving unit.

FIG. 12 is a perspective view showing the detector and its rotation axis.

FIG. 13 is a plan view showing a sample transfer process.

FIGS. 14A and 14B are side views of the main unit at 0° and 50° receiving units, respectively.

### DETAILED DESCRIPTION OF THE INVENTION

Next, embodiments of the present invention are described with reference to the drawings. To facilitate understanding of the description, the same reference numerals are assigned to the same components in the respective drawings, and duplicate descriptions are omitted.

### Inspection Subject

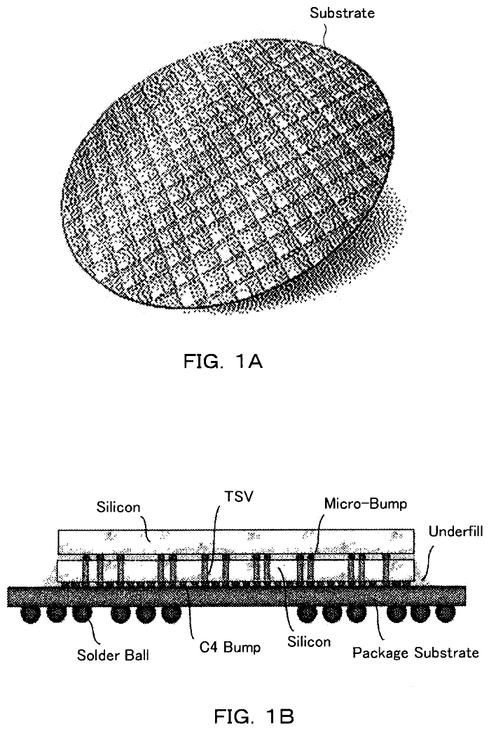

The sample to be inspected by the X-ray inspection apparatus is, for example, a substrate on which wiring or the like is formed on a wafer. The sample is a plate-like structure mainly made of high-purity single-crystal silicon, and is formed as, for example, a disk having a diameter of 300 mm and a thickness of several hundreds of micrometers. The sample processed by etching, film formation or the like is inspected. FIGS. 1A and 1B show a sample and package to be inspected, respectively.

After the substrate is diced for each chip (Dicing), each of the chips is sealed for electrical connection and physical protection to the outside, thereby forming a package. The package has a fine structure. In the package, a TSV (Through-Silicon Via for transmitting electric signals vertically in the chip, a Micro-Bump for connecting the chips, and a C4 Bump for connecting the chip and the Package Substrate are provided. An insulating resin called an Underfill is filled between the chip and the substrate, and a Solder Ball is provided as an external connecting terminal of the package substrate.

In the semiconductor manufacturing process, defects such as voids, cracks, and metal-filling defects in TSV, voids in bonding and underfill, peeling, unbonded portions and foreign matters, voids, bridges, misalignments and cracks in solder joints are checked by inspection. Among such inspection processes, in particular, the X-ray inspection system is excellent in checking the presence or absence, the position, the state and the like of defects in the internal structure at the stage of providing the substrate. The sample also can be a glass member or a resin substrate other than the silicon substrate. In addition, a package obtained by cutting wafer or glass into individual pieces can also be an inspection target.

### X-ray Inspection System

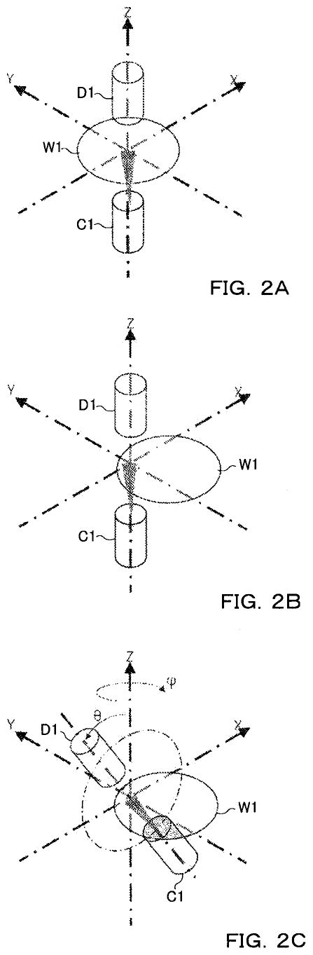

The X-ray inspection system irradiates X-rays from an X-ray source under the control of a user, and detects X-rays transmitted through a sample (disk-shaped substrate) by a detector, thereby enabling imaging and laminography. FIGS. 2A to 2C are schematic diagrams showing arrangements of an X-ray source and detector for imaging and laminography of central and peripheral regions, respectively. The X-rays are irradiated from the vertical lower side to the upper side. The X-axis, the Y-axis, and the Z-axis shown in FIGS. 2A to 2C configure a sample coordinate system (or a coordinate system of the sample stage).

In the embodiment shown in FIG. 2A, X-rays irradiated from the X-ray source C1 are transmitted through the sample W1, and a transmission image is acquired by the detector D1. As shown in FIG. 2B, the sample W1 is placed so as to be movable respectively on the X-axis and the Y-axis of the sample stage. In the embodiment shown in FIG. 2C, the X-ray source C1 and the detector D1 are tilted by θ from an axis perpendicular to the surface of the sample W1, and the sample W1 is rotated to perform the measurement. Note that the projection image represents the intensity distribution of the X-rays transmitted through the sample as data acquired from a predetermined angle and includes a so-called transmission image.

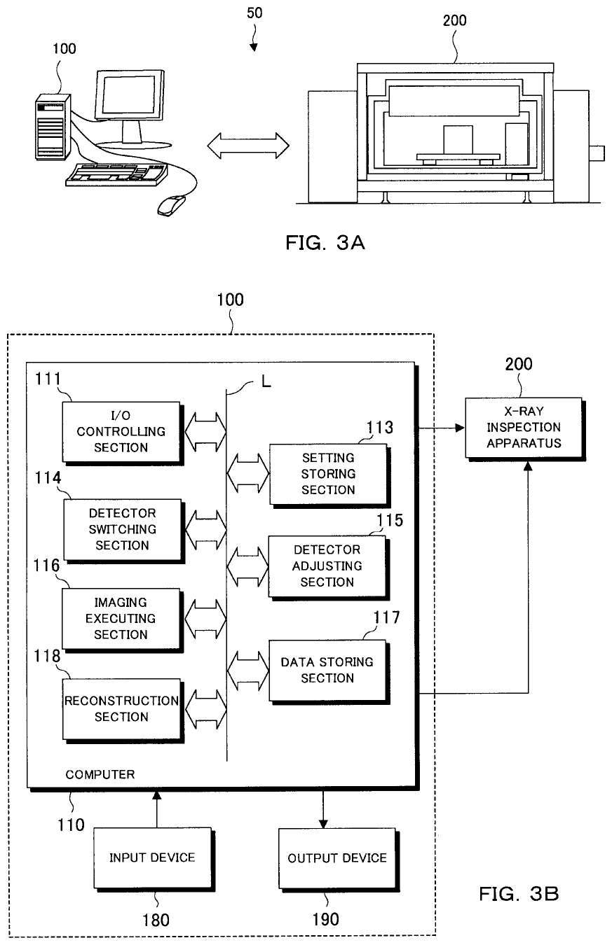

FIG. 3A is a schematic diagram of an X-ray inspection system 50. The X-ray inspection system 50 comprises a control apparatus 100 and an X-ray inspection apparatus 200. The control apparatus 100 and the X-ray inspection apparatus 200 are connected to each other by wire or wirelessly so as to be able to transmit information. The control apparatus 100 transmits a control instruction to the X-ray inspection apparatus 200 by the user's operation. The X-ray inspection apparatus 200 operates in response to the control instruction and performs inspection of a sample.

FIG. 3B is a block diagram showing functionally the X-ray inspection system 50. The control apparatus 100 comprises a computer 110, an input device 180 and an output device 190, receives an input from a user, controls the X-ray inspection apparatus 200 to acquire a projection image and performs processing and display thereof. The functions of the control apparatus 100 are mainly realized by the computer 110. The computer 110 comprises an I/O controlling section 111, a setting storing section 113, a detector switching section 114, a detector adjusting section 115, an imaging executing section 116, a data storing section 117, and a reconstruction section 118. Each section can transmit and receive information via the control bus L.

The control apparatus 100 is constituted from a computer formed by connecting CPU (Central Processing Unit/Central Processor), ROM (Read Only Memory), RAM (Random Access Memory) and a memory to a bus. The control apparatus 100 may be a PC terminal or a server on the cloud. Not only the whole apparatus but also part of the apparatus or some functions of the apparatus may be provided on the cloud.

The I/O controlling section 111 receives an input from the input device 180 and controls an output to the outputting device 190. The setting storing section 113 stores setting information such as an arrangement of detectors. The detector switching section 114 transmits a switching instruction for the detector to the X-ray inspection apparatus 200 and controls the switching of the detector. It is preferable to select a detector to be used automatically based on the designation of the projection image or the three-dimensional image to be measured after the designation from the user is accepted. It should be noted that selection of the detector by the user oneself is also acceptable if necessary.

The detector adjusting section 115 adjusts the arrangement of the detector before imaging. In the case where the positional information of the sample and the detector is used, the relative position between the sample and the detector may be determined, and the arrangement of the detector may be adjusted based on the relative position. The imaging executing section 116 transmits the control instruction to the X-ray inspection apparatus 200 to image the placed sample. The data storing section 117 stores data of the acquired projection image. The reconstruction section 118 reconstructs the three-dimensional image using the stored data of the projection image.

### X-ray Inspection Apparatus

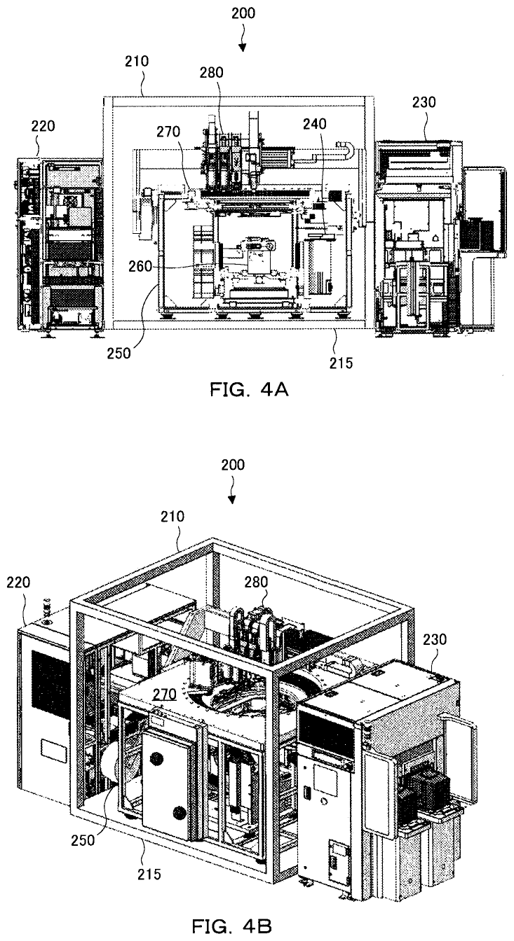

The X-ray inspection apparatus 200 performs measurement by irradiating the sample with X-rays and acquiring a projection image. FIGS. 4A and 4B are cross-sectional and perspective views of the X-ray inspection apparatus 200, respectively. As shown in FIGS. 4A and 4B, the X-ray inspection apparatus 200 comprises a frame upper part 210, a frame lower part 215, an electrical box 220, an EFEM 230, an intermediate transfer system 240, a main unit 250, an incident unit 260, a sample stage 270, and a receiving unit 280.

The frame upper part 210 has a skeleton formed along the side of the cube surrounding the main unit 250, and its open end on the vertical lower side is connected to the frame lower part 215. The frame lower part 215 is formed in a plate shape and supports the main unit 250. Although not shown, the main unit 250 is covered with panels that shield X-rays. The electrical box 220 has a PLC, a power supply control device and the like. The EFEM 230 (Equipment Front End Module) is a relay device that connects the main unit 250 and the transport system in the factory. The intermediate transfer system 240 has a robotic arm and transfers the sample received from the EFEM 230 to the sample stage 270. The main unit 250 comprises an incident unit 260, a sample stage 270, and a receiving unit 280, and performs placement of a sample, irradiation and detection of X-rays.

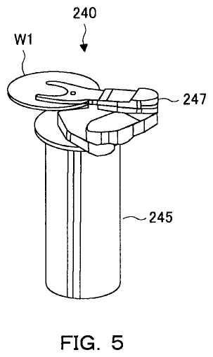

FIG. 5 is a perspective view showing an intermediate transfer system 240. The intermediate transfer system 240 comprises a support table 245 and a robot arm 247. The support table 245 is formed in a cylindrical shape with a diameter equivalent to the substrate diameter and supports the robot arm 247. The robotic arm 247 holds the sample W1 and transports it to the sample stage 270. In the intermediate transfer system 240 shown in FIG. 5, the robot arm 247 holds the sample W1.

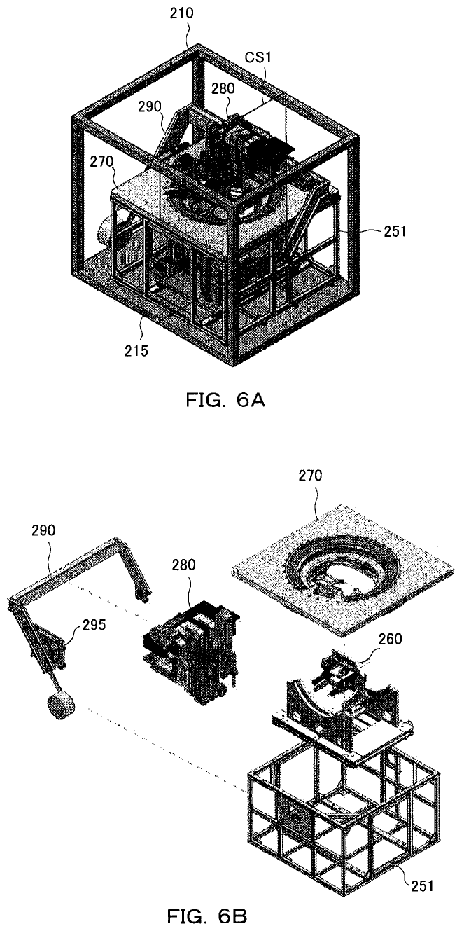

The main unit 250 has the main functions of a device such as holding a sample W1, irradiation an X-ray, and detecting a projected image. FIGS. 6A and 6B are perspective and exploded views showing the main unit 250, respectively. As shown in FIGS. 6A and 6B, the main unit 250 is supported by the frame lower part 215, is surrounded by the frame upper part 210 and comprises an inner frame 251, an incident unit 260, a sample stage 270, a receiving unit 280, an arm 290, and a goniometer 295.

The inner frame 251 is formed as a grating box in which a frame body has a skeleton and a vertical upper portion is opened. The incident unit 260 is housed at the bottom of the inner frame 251 and irradiates parallel X-rays toward the sample the sample from vertically below. Parallel X-rays include X-rays that have a convergence or divergence to the extent that they are irradiated at a substantially constant incident angle on an irradiated object and do not affect the measurement or detection results. A peripheral edge part of the sample stage 270 is fixed to a frame forming an opening part in the inner frame 251. The sample stage 270 holds a disk-shaped sample and adjusts the arrangement of the sample.

The receiving unit 280 is mounted on an arm outer part formed at a position where the rotational radius of the arm 290 is maximized and detects X-rays transmitted through the sample on vertically above of the sample W1. The arm 290 is connected to the goniometer 295 and is controlled by the goniometer 295. The goniometer 295 is installed on the inner frame 251 so as to be able to control the angle around the rotation axis. Thus, the projection image can be acquired at an angle tilted from the sample axis.

### Incident Unit

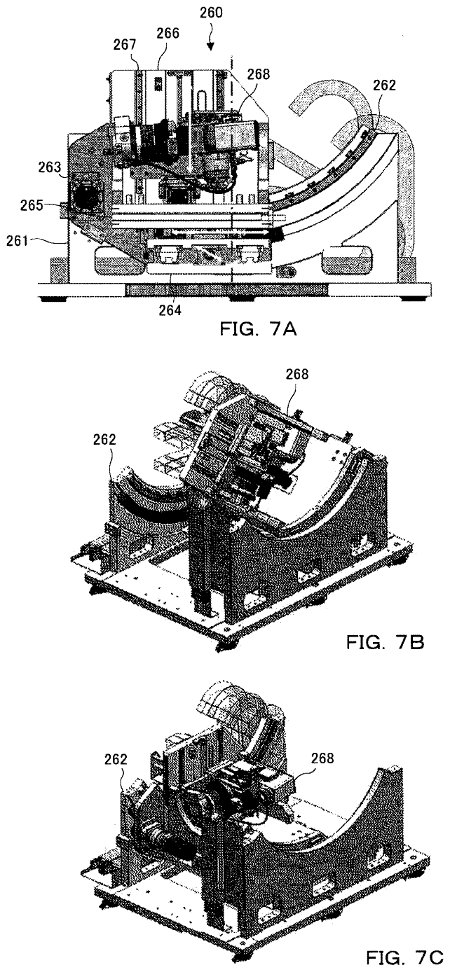

The incident unit is a mechanism for irradiating X-rays at a predetermined angle. FIGS. 7A to 7C are side cross-sectional and perspective views for different arrangements showing an incident unit 260, respectively. As shown in FIGS. 7A to 7C, the incident unit 260 comprises an incident unit base 261, a θ-axis R guide 262, a θ-axis motor 263, a Y₁ axis LM guide part 264, a X₁ axis LM guide part 265, a guide plate 266, an Z₁ axis LM guide 267, and an X-ray source 268. The coordinate system of the incident unit 260 and the receiving unit 280 is represented by X₁ axis, Y₁ axis and Z₁ axis.

The incident unit base 261 is fixed to the bottom of the inner frame 251 and supports the entire incident unit 260. The θ-axis R guide part 262 is provided on the incident unit base 261 and has rails of arc tracks for rotating the X-ray source 268 around the θ-axis. From the viewpoint of the stability of the movement, it is preferable that there are two rails (the same applies hereinafter).

The θ-axis motor 263 provides a driving force for rotating the X-ray source 268 around the θ-axis. Note that the θ-axis rotation direction of the X-ray source 268 coincides with the θ-axis rotation direction of the arm 290, and a projection image at a predetermined θ angle is acquired by interlocking the operations of the two. The Y-axis of the sample stage 270 and Y₁ axis of the incident unit 260 and the receiving unit 280 are equivalent to the θ-axis and are the same.

The Y₁ axis LM guide part 264 is provided on the θ-axis R guide part 262. The rails for moving the X-ray source 268 in Y₁ axis direction (θ-axis direction) are formed in the Y₁ axis LM guide part 264. The X₁ axis LM guide part 265 is provided on the Y₁ axis LM guide part 264. The X₁ axis LM guide part 265 is formed with a rail that moves the X-ray source 268 in the X₁ axis direction (a direction perpendicular to the Y₁ axis and Z₁ axis).

The guide plate 266 is provided on the X₁ axis LM guide part 265. The guide plate 266 is formed with a Z₁ axis LM guide 267 as a rail for moving the X-ray source 268 in Z₁ axial direction (X-ray irradiating direction). The X-ray source 268 is connected to the guide plate 266 so as to be movable on Z₁ axial LM guide 267. The X-ray source 268 irradiates the sample W1 with parallel X-rays.

### Sample Stage

The sample stage 270 holds the sample W1 and can independently position the sample W1 in the X-axis direction (horizontal direction perpendicular to the Y-axis), the Y-axis direction (θ-axis direction), the Z-axis direction (direction perpendicular to XY plane), and the rotational direction around the center axis (sample axis) perpendicular to the sample surface. The sample stage 270 can also rotate the sample W1 around the sample axis perpendicular to the surface of the sample W1 during X-ray irradiation.

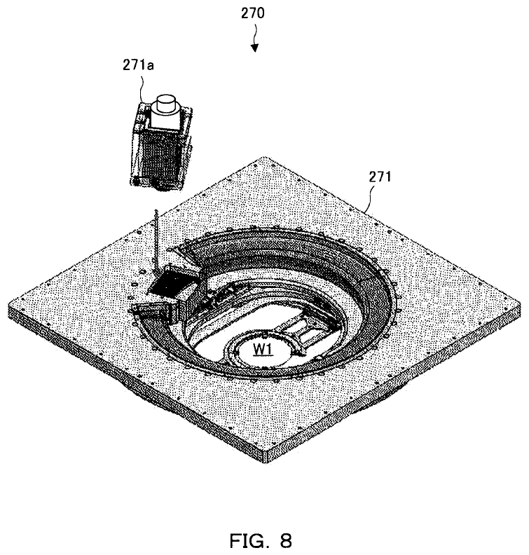

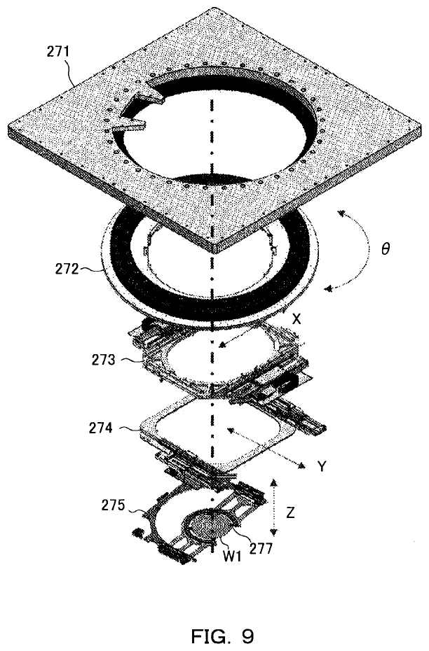

FIG. 8 is a perspective view showing the sample stage 270. FIG. 9 is a perspective exploded view showing the sample stage 270. The sample stage 270 comprises a stage base 271, a θ rotation base 272, an X-axis base 273, a Y-axis base 274 and a Z-axis base 275.

The stage base 271 comprises a body part 271a and a θ rotation motor 272a and is fixed to an edge of an upper end opening of the inner frame 251. The stage base 271 supports the θ rotation base 272 so that it can perform θ rotation. The body part 271a is formed as a plate having a circular hole in the central thereof, and the θ rotation motor 272a provides a driving force for rotation to the θ rotation base 272.

The θ rotation base 272 is provided on the stage base 271 via bearings and can rotate around the central axis of the sample W1 by 360° or more with the driving force of the θ rotation motor 272a. The X-axis base 273 is provided on the θ rotation base 272 and can be positioned in the X-axis direction in a range (for example, ±160 mm) of the diameter of the sample W1 or larger. The Y-axis base 274 is provided on the X-axis base 273 and can be positioned in the Y-axis direction in a range (for example, ±160 mm) of the diameter of the sample W1 or larger. It is preferable that the X-axis direction and the Y-axis direction moving mechanisms control the sliding movement by the driving force of the motor using LM guides by linear encoders.

The Z-axis base 275 is provided on the Y-axis base 274 and can be positioned in the Z-axis direction in a range (for example, ±3 mm) of the thickness of the sample W1 or larger. The moving mechanism preferably transmits the driving force of the motor to the Z-axis base 275 via a helical gear or the like to enable fine adjustment by sliding movement.

The Z-axis base 275 comprises four chucks 277. The chucks 277 are fixtures for vacuum-fixing the peripheral portion of the sample W1. The number of the chucks 277 is preferably three or more from the viewpoint of stably holding the sample W1. Each of the θ rotation base 272, the X-axis base 273, the Y-axis base 274 and the Z-axis base 275 has a hole in the central thereof and is designed so that the X-rays do not pass through other than the sample. In addition, an axial movement mechanism is provided.

### Receiving Unit

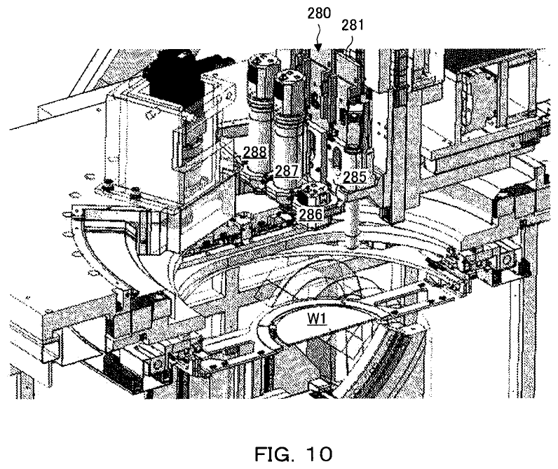

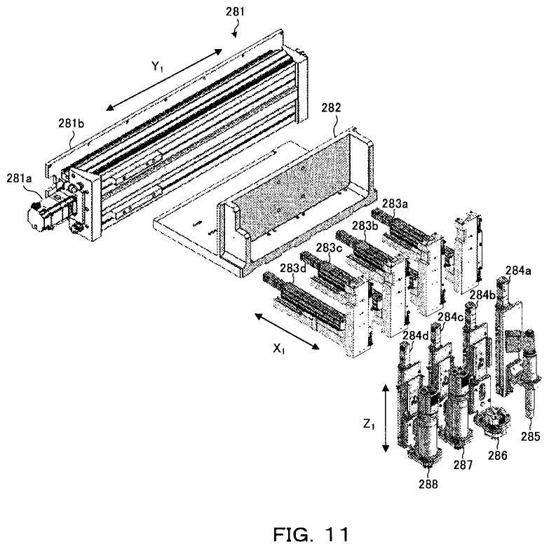

The receiving unit 280 comprises a plurality of detectors and detects X-rays transmitted through the sample W1 by one selected detector. FIG. 10 is a perspective cross-sectional view showing a part of the main unit 250 (cross-sectional view according to the cross section CS1 shown in FIG. 6). FIG. 11 is a perspective exploded view of the receiving unit 280.

The receiving unit 280 comprises a switching mechanism 281, a receiving unit base 282, a X₁ axis adjusting mechanisms 283a to 283d, Z₁ axis adjusting mechanisms 284a to 284d, an optical microscope 285, a topo detector 286, a first detector 287 and a second detector 288.

The switching device 281 comprises a rod 281a and a body part 281b. The rod 281a is fixed to the arm outer part of the arm 290 with the longitudinal direction along Y₁ axial direction (θ-axis direction). The body part 281b is arranged along the rod 281a and is movably mounted on the rod 281a. The plurality of detectors 286 to 288 are arranged such that a central axis of the central of the detection surface is arranged in a row along a specific direction.

The switching mechanism 281 moves the body part 281b along the rod 281a to position the optical microscope 285 or the detectors 286 to 288 on the optical axis of the X-ray. Thus, the user can select an arbitrary detector or optical microscope according to the observation object and can switch these accurately and quickly. The switching mechanism 281 also functions as an Y₁ axis adjusting mechanism for the optical microscope 285 and the detectors 286 to 288.

The receiving unit base 282 is fixed to the body part 281b of the switching mechanism 281, and the reference position of the detectors 286 to 288 is determined by the receiving unit base 282. The reference position is specified by a position (X, Y, Z) in the sample coordinate system and a predetermined direction and is used as a reference for adjusting the detectors 286 to 288. By setting the reference position, the sample can be measured with a spatial resolution and a field of view that always have a certain accuracy or more.

The optical microscopes 285 and X₁ axis adjusting mechanisms 283a to 283d of the respective detectors 286 to 288 are slidably attached to the receiving unit base 282. The position on X₁ axis of the optical microscope 285 and the detectors 286 to 288 can be independently adjusted by X₁ axis adjusting mechanisms 283a to 283d. X₁ axis direction is a direction perpendicular to Y₁ axis and Z₁ axis.

Each of Z₁ axis adjusting mechanisms 284a to 284d is slidably attached to X₁ axis adjusting mechanisms 283a to 283d. Z₁ axis adjusting mechanisms 284a to 284d can independently adjust the position of the optical microscope 285 and the detectors 286 to 288 on Z₁ axis. Z₁ axis is the X-ray irradiation direction.

The Z₁ axis adjusting mechanisms 284a to 284d enables each of the detectors to be moved to a position close to or away from the sample along the optical axis of the irradiated X-ray. Thus, when it is necessary to observe a large range at a low magnification and observe a small range at a high magnification, it is possible to observe the sample with a detector suitable for each application in a single apparatus. In particular, when the sample W1 is observed at a high magnification, the distance between the detector 286 to 288 and the sample W1 can be set to 1 mm or less when the X-ray incident angle is perpendicular to the sample surface. When the X-ray is incident obliquely to the sample surface, the distance is set larger than the above to prevent the camera from interfering with the substrate. For example, when the incident angle is 10°, the distance is set to 8 mm or less. Thus, distortion of the periphery of the projection image does not occur, and an effective field of view can be increased. Thus, distortion of the periphery of the projection image does not occur, and an effective field of view can be increased.

The optical microscope 285 determines an X-ray irradiation position on the sample surface and specifies an observation position. As a result, the optical microscope 285 is also used to align the optical axis of the optical microscope in the X-ray irradiation direction by aligning the optical axis of the optical microscope coaxially with the X-ray irradiation direction. The optical axis of the irradiated X-rays can be aligned with the reference position of each of the detectors 286 to 288, so that the arrangement of each of the detectors 286 to 288 can be easily adjusted.

Each detector 286 to 288 has a distinct field of view (FOV) and resolution and detects a projection image of X-rays transmitted through the sample W1, respectively. In this embodiment, the detectors 286 to 288 may be configured to include, for example, three different types of cameras.

The topo detector 286 with the largest FOV detects a projection image of a partial area of the sample W1. The acquired projection image is used to align the observation position of the sample W1 and to confirm the presence or absence of a defect. The first detector 287 has a large field of view and can be used to locate defects in the internal structure. For example, the first detector 287 is an X-ray camera with intermediate resolution, and also has an internal lens, with a resolution of 1.5 μm and an FOV of 9.4×6.3 mm.

Then, with respect to the position of the defect specified by the first detector 287, a magnified image can be acquired by the second detector 288 having a high resolution, and the state of the defect can be observed. For example, the second detector 288 is an X-ray camera with the highest resolution, and has an internal lens that makes the magnification of the image higher to obtain high resolution, with a pixel size representing the resolution of 0.2 μm or less and an FOV of 1.7×1.1 mm.

In this way, it is preferable that the respective detectors 286 to 288 share roles in stages. In this case, at the time of switching, the detector is aligned using basically known calibration data. Further, the position information may be specified by pattern recognition of the projection image acquired by the detector before the switching, and the arrangement of the detector after the switching may be adjusted by using the obtained position information. The process of specifying the position information from the pattern recognition can be executed by the control apparatus 100.

Further, after the defect position is specified by the imaging measurement using the first detector 287 as described above, the image acquisition may be performed using the second detector 288 by the laminography measurement. In this way, it is also possible to switch the detector used according to the measurement type, and to quickly switch the two measurements to perform an efficient inspection. In this way, based on the projection image acquired by the second detector 288, it is also possible to quantitatively calculate what percentage the volume of the void occupies with respect to the fixed region.

In this embodiment, for example, of the above detectors, the topo detector 286 is used only for imaging measurements. On the other hand, the first detector 287 and/or the second detector 288 are used for both imaging and laminography measurement. In this way, it is also possible to distinguish the detectors in the application. Detectors with high frame rates can also be used for laminography measurements. Note that the above-described embodiment is an example, and the performance and role sharing of each detector are not limited to the above-described example.

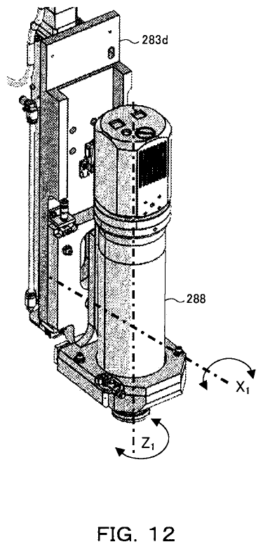

As described above, the positions of the optical microscope 285 and the detectors 286 to 288 on X₁ and Y₁ and Z₁ axes, respectively, are precisely adjusted. Furthermore, the angular position about each axis is also accurately adjusted. FIG. 12 is a perspective view showing the second detector 288 and its rotation axes.

As shown in FIG. 12, the second detector 288 can be controlled to accurately adjust the angle around X₁ axis and Z₁ axis. The adjustment around Y₁ axis can be performed by at least one of the angular adjustment by the goniometer of the arm 290 and the adjustment by the X-ray source 268. The optical microscope 285 and detectors 286 to 287 can also be accurately angulated around X₁ axis, around Y₁ axis and around Z₁ axis, respectively, similar to the second detector 288. In this way, the optical microscope 285 and the adjustment mechanism for each detector 286 to 287 can independently adjust their respective arrangements accurately.

### System Operation

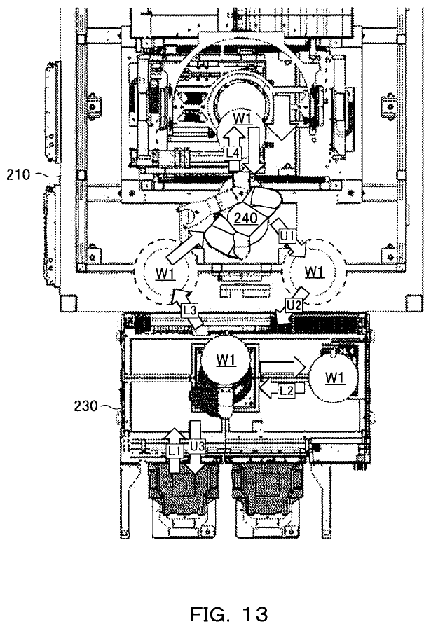

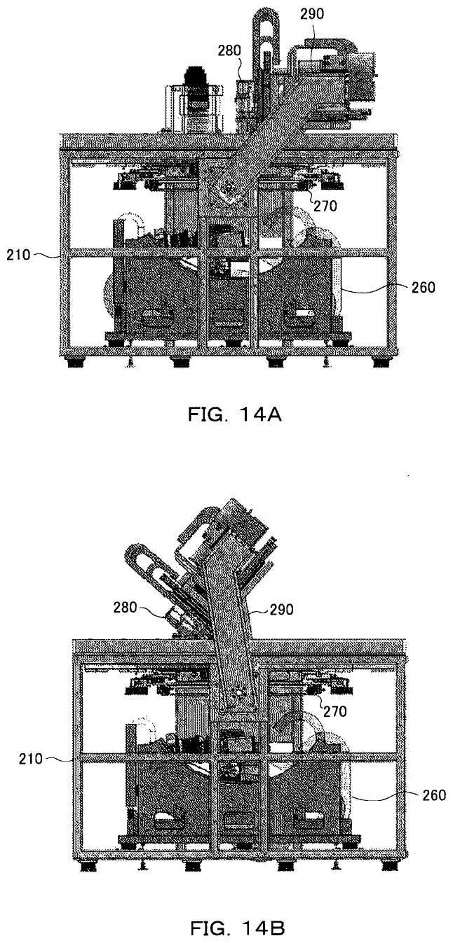

An example of the operation of the X-ray inspection system 50 configured as described above is described. First, the sample is placed on the sample stage 270 in the X-ray inspection apparatus 200. FIG. 13 is a plan view showing a sample transfer process. FIGS. 14A and 14B are side views of the main unit at 0° and 50° receiving units, respectively.

As shown in FIG. 13, a sample (disk-shaped substrate) W1 to be inspected is picked up from LP (load port), placed on the aligner (operation L1), the notch angle of the sample is aligned by the aligner (operation L2), and the sample is placed on the intermediate stage (operation L3). Then, the sample W1 is gripped by the robot arm 247 of the intermediate transfer system 240 and placed on the sample stage 270 (operation L4).

At the time of inspection, for example, an imaging condition is selected, and a projection image is first acquired for a specific area of the sample W1 in a large field of view by the imaging mode. In this case, the first detector 287 with a large field of view is selected, and the switching mechanism 281 switches the detector in use to the first detector 287. Based on the adjustment data, the adjustment mechanisms (281) and 283c, 284c adjust the arrangement of the first detector 287.

When a defect cannot be confirmed in the internal structure by observation of a large field of view, the position of the sample stage 270 is adjusted, and a projection image is acquired for another range. When a defect is found, a projection image is acquired at a high magnification for a region of interest including the defect. In this case, the second detector 288 with a high magnification and high resolution is selected, and the switching mechanism 281 switches the detector in use to the second detector 288. The switching operation may be performed immediately after the defect is found or may be performed separately offline.

Then, based on the adjustment data, adjustment mechanism (281), 283d, 284d adjusts the arrangement of the second detector 288, the second detector 288 acquires the projected image. In addition, if the three-dimensional structure of the region of interest is to be confirmed, the control apparatus 100 instructs the laminography measurement.

The X-ray inspection apparatus 200 adjusts the positions of the incident unit 260 and the arm 290 from θ=0° (FIG. 14A) to θ=50° (FIG. 14B), for example, and acquires a plurality of projection images while rotating the sample stage 270. The control apparatus 100 reconstructs a three-dimensional image from the acquired projection image. The angle θ of the X-ray irradiation direction can be finely adjusted to a specific angle of 0 to 50°.

As described above, in the imaging measurement, the X-ray inspection apparatus 200 acquires a projection image by aligning the optical axis of the X-ray to be irradiated with the sample axis. In the laminography measurement, the optical axis of the X-ray to be irradiated is tilted from the sample axis while the intersection of the optical axis of the X-ray to be irradiated and the sample axis coincides with the observation position of the sample, and a plurality of projection images are acquired while the sample is rotated. Thus, imaging measurements and laminography measurements can be executed on a single apparatus.

After the inspection, the sample W1 is returned to the primary process. Specifically, the sample W1 is placed on the intermediate stage (operation U1), the sample W1 is gripped by the robot arm 247 of the intermediate transfer system 240 (operation U2), and the sample W1 is returned to LP (load port) (operation U3), whereby a series of inspection processes is completed.

### DESCRIPTION OF SYMBOLS

50 X-ray inspection system
100 control apparatus
110 computer
111 I/O controlling section
113 setting storing section
114 detector switching section
115 detector adjusting section
116 imaging executing section
117 data storing section
118 reconstruction section
180 input device
190 output device
200 X-ray inspection apparatus
210 frame upper part
215 frame lower part
220 electrical box
240 intermediate transfer system
245 support table
247 robot arm
250 main unit
251 internal frame
260 incident unit
261 incident unit base
262 θ-axis R guide part
263 θ-axis motor
264 Y₁ axis LM guide part
265 X₁ axis LM guide part
266 guide plate
267 Z₁ axis LM guide
268 X-ray source
270 sample stage
271 stage base
271a body part
272 θ rotation base
272a θ rotation motor
273 X-axis base
274 Y-axis base
275 Z-axis base
277 chuck
280 receiving unit
281 switching mechanism (Y₁ axis adjusting mechanism)
281a rod
281b body part
282 receiving unit base
283a to 283d X₁ axis adjusting mechanism
284a to 284d Z₁ axis adjusting mechanism
285 optical microscope
286 topo detector
287 first detector
288 second detector
290 arm
295 goniometer
C1 X-ray source
D1 detector
L control bus
W1 sample
θ angle

What is claimed is:

1. An X-ray inspection apparatus comprising:
an X-ray source for irradiating parallel X-rays with a plate-shaped sample;
a sample stage for holding the sample;
a plurality of detectors each having a different resolution and detecting a projection image of X-rays transmitted through the sample;
a switching mechanism for switching the detectors; and
an adjusting mechanism for adjusting an arrangement of each of the detectors independently,
wherein the adjusting mechanism enables each of the detectors to move in a direction close to or away from the sample along an optical axis of the irradiated X-rays.

2. The X-ray inspection apparatus according to claim 1, further comprising
an optical microscope for setting an X-ray irradiation position on a surface of the sample and aligning an optical axis of the irradiated X-ray with a reference position of the detector.

3. The X-ray inspection apparatus according to claim 1,
wherein the detectors include a detector for specifying a position of a defect in the sample and a detector for observing a state of the defect.

4. The X-ray inspection apparatus according to claim 1,
wherein the sample stage is capable of rotating the sample around a sample axis perpendicular to the surface of the sample,
in an imaging measurement, an optical axis of the irradiated X-ray is aligned with the sample axis, and the projection image is acquired, and
in a laminography measurement, an intersection between an optical axis of the irradiated X-ray and the sample axis is aligned with an observation position of the sample, and the optical axis of the irradiated X-ray is tilted from the sample axis, and the plurality of projection images are acquired while rotating the sample.

5. The X-ray inspection apparatus according to claim 4,
wherein the detectors include a detector used only for the imaging measurement and a detector used for both the imaging and the laminography measurement.

6. The X-ray inspection apparatus according to claim 1,
wherein the plurality of detectors are arranged such that central axes each in a center of a detection surface are arranged in a row, and
the switching mechanism switches the detectors by moving the entire plurality of detectors along a direction of the arrangement.

7. An X-ray inspection system comprising: the X-ray inspection apparatus according to claim 1, and
a control apparatus for controlling the X-ray inspection apparatus,
wherein the control apparatus adjusts the arrangement of the switched detector by pattern recognition of the projected image.
